(19) United States
(12) Patent Application Publication
(10) Pub. No.: US 2009/0291201 A1
(43) Pub. Date: Nov. 26, 2009

(54) METHOD FOR INCREASING THE SURFACE CONDUCTIVITY OF A POLYMER USED IN A TUNEABLE DIFFRACTION GRATING (TDG) MODULATOR

(75) Inventors: Lars Henriksen, Tonsberg (NO); Vladimir Kartashov, Horten (NO); Morten Eliassen, Sandefjord (NO); Gunnar Hedin, Tyreso (SE)

Correspondence Address: KNOBBE MARTENS OLSON & BEAR LLP, 2040 MAIN STREET, FOURTEENTH FLOOR, IRVINE, CA, 92614, US

(73) Assignee: Polight AS , a Norwegian Corporation

(21) Appl. No.: 12/096,582

(22) PCT Filed: Dec. 6, 2006
(86) PCT No.: PCT/NO2006/000464

§ 371 Date: Nov. 4, 2008

(30) Foreign Application Priority Data
Dec. 6, 2005 (NO) 20055782

(51) Int. Cl. B05D 5/12; H01B 1/20

(52) U.S. Cl. 427/108; 252/500

(57) ABSTRACT

The present invention relates to methods for increasing the surface conductivity of a polymer used in tuneable diffraction grating (TDG) modulators while at the same time maintaining the total internal reflection (TIR) and transparency.

### BACKGROUND OF THE INVENTION

This invention relates to the field of Tuneable Diffraction Grating (TDG) optical chips based on the principle of total internal reflection (TIR) as exemplified by U.S. Pat. No. 6,897,995. More specifically the present invention relates to methods for increasing the surface conductivity of a polymer used in such devices.

Examples of application areas for the TDG chip are telecom (optical communications) (FIG. 1) and display (FIG. 2). Both markets represent an increasing demand for price-competitive technologies that allow for mass production with high yield, thereby offering new products and services to the end-users.

The working principle for the TDG is the surface modulation of a polymer film by electrical fields imposed by electrodes on a substrate. Details of the function of the TDG modulator are described in for example U.S. Pat. No. 6,897,995 (detailed in FIG. 3). The polymer can be any macromolecular network with an appropriate swelling agent, or an elastomer. The by far most promising polymer system has been silicone gels, more accurately polydimethyl siloxane (PDMS) gels, examples of this are given in WO 01/48531.

The TDG modulators, which this invention relates to, are based on total internal reflection of incoming light in an interface polymer gel/air. This construction is fundamentally different from other, well known light modulators, based on a deformable polymer sandwiched between two electrode sets. There are two fundamental differences; one is that light does not pass through the polymer film, the other is that the physics responsible for the deformation is different.

A light modulator based on total internal reflection has the advantages of having 100% optical efficiency, in contrast to metallic reflection, that typically is 80-90%. In applications with high optical flux, the fraction non-reflected light will lead to heat generation and will give additional demands to the construction of the modulator. In many applications (for example telecom and display), the optical efficiency of an actuating device will be a crucial parameter that contributes to the overall quality of the device.

From a physical point of view, light modulators based on total internal reflection, can be described with the same set of equations as light modulators that are built up of a deformable material (a polymer) between two electrode sets, as exemplified by Uma et al. (in IEEE J. Sel. Topics in Quantum Elec., 10 (3), 2004), Gerhard-Mülthaupt (in Displays, Technol. Applicat., 12, 115-128, 1991) etc.

The basic differences between the two types are a) TIR modulators have two dissimilar materials (air and polymer), b) the polymer/gel film in a TIR modulator must be transparent and c) forces in reflective modulators origin from discrete electrical charges, while in TIR modulators, dipole orientation has an effect.

In practice, these differences mean that the polymer film in reflective modulators may be of any kind that is deformable (including for example non-transparent materials), while for TIR-modulators, the significance of transparency and dipole dislocations is evident. To a person skilled in the art, it is therefore obvious that there are completely different requirements to the polymer film in light modulators based on the TIR principle than in reflective modulators.

The dynamic response, given by the time to reach say 90% of the desired relief amplitude, and the sensitivity of the TDG modulator, given by the relief amplitude per applied volt, are both critical parameters for the operation of the modulator. These parameters are controlled by adjusting the composition of the gel and geometric parameters, such as gel thickness and gap between gel and electrodes. What time constant is required will depend on the application the TDG modulator is intended for.

The superior behavior of PDMS gels is due to the high degree of polymer chain flexibility, giving materials that remain soft and deformable at a wide temperature range. One well known artifact of silicones in general and PDMS in particular is the extremely low electrical conductivity. PDMS is often denoted a pure dielectric, and its properties are indeed suitable in a wide range of applications.

This low conductivity will, however, cause unwanted effects during operation of a TDG modulator. In particular, when the rate of electrical charge transport is lower than the viscoelastic response of the gel film, a complex behavior of the relief amplitude as a function of drive voltage and time is seen. The presence of multiple time constants when a step voltage is set up may cause unwanted effects upon dynamic operation of a TDG modulator. Depending on the application, these effects may be: a too slow response to the voltage pulse onset, memory effects and stray light.

### OBJECTS OF THE INVENTION

The main object of the invention is to provide a polymer film. for TDG modulators where the above described complex behavior of the polymer film is eliminated; resulting in only one time constant, suitable for the application the modulator is intended for.

An object of the invention is therefore to provide methods for increasing the surface conductivity of silicone polymers intended for use in TDG modulators, without influencing negatively on other important parameters of the polymer film.

### BRIEF SUMMARY OF THE INVENTION

The use of macromolecular gels in TDG modulators is described well in for example U.S. Pat. No. 6,897,995. The principle of operation is the formation of a nonuniform electrical field that creates a force on the surface of the polymer gel film. The main principle of operation of a polymer film based TDG modulator is described stepwise below (See FIG. 3 for a schematic description):
The macromolecular gel is located as a thin film on the surface of a prism
The gel surface is assembled at a fixed given distance from an electrode substrate
The electrodes are patterned, giving parallel electrodes that are connected alternately
A bias voltage is set up on or behind the gel surface and the electrode substrate
Signal voltage is applied to every second electrode (or positive to one and negative to the next)
A nonuniform electrical field is thus formed, which creates a force on the deformable gel film
The gel film is deformed according to the electrical field, giving a spatial surface modulation determined by the electrode pattern and the voltages imposed on the device.
The modulation imposed on the surface scatters incoming light as required by the end application. When the surface is not modulated, the incoming light experiences total internal reflection in the interface between the gel and the gas gap.

Due to a small, non-zero electrical conductivity, that in the case of silicones mainly origins from dipole or ionic conductance, the bias voltage will after a given time be between the gel surface and the electrode substrate. Conceptually, charges are now located on the gel film surface. A schematic presentation of the combined effect of charge transport and deformation of gel film is given in FIG. 5. Due to the non-zero electrical surface conductivity, there will be transport of charges across the gel surface, causing an accumulation of for example positive charges above negative electrodes and vice versa. This accumulation of charges will then lead to an increased force on the gel film, consequently giving additional contribution to the relief amplitude. For silicone gels, the charge transport rate will in some cases be slower than the viscoelastic response of the gel to the force originating from the nonuniform electrical field. This will again lead to multiple time constants. One example with viscoelastic response significantly quicker than the rate of charge transport is shown in FIG. 4: the first response is the viscoelastic response before dislocation of surface charges, the second response is in the regime where the charge transport rate is the rate determining.

The viscoelastic response of the polymer film to the applied electrical field is determined by parameters such as storage and loss moduli, and can be controlled by conventional methods.

The rate of dislocation of charges on the surface of the polymer film can be expressed by for example the surface conductivity. In many cases, the surface conductivity is directly related to the bulk conductivity. However, other factors, such as surface defects and impurities can contribute significantly, especially in cases where the polymer itself has a very low conductivity.

In order to exemplify problems that can be seen when there is a conflict between the viscoelastic, charge transport rate and the required response of the TDG modulator, the following case is presented:

It is assumed that the viscoelastic response is quicker than the surface charge transport rate. If the TDG modulator is operated in a regime where the required response time is in conflict with the surface charge transport rate, two problems are evident:
1) Due to the limited surface charge transport rate, the full potential of the relief amplitude for a given voltage is not exploited, and
2) With subsequent signal pulses, charges may accumulate, leading to a memory effect in the modulator, and a complex relief amplitude development as a function of time.

These problems may for example put high demands on the electronic driving of the modulator, cause stray light in display applications and instable operation in general.

For a TDG modulator based on the TIR principle, it is not trivial to increase the conductivity of the polymer film, or the polymer film surface. This is in contradiction to light modulators with a reflective (metal) surface. In those light modulators, the reflective surface acts both as a mirror and as an electrode for the control of the periodic surface deformation (the grating). Reflective surfaces (mirrors) are most commonly metals. Metals are reflective due to their electrical conductivity. For the TIR light modulators, it is not a trivial to increase the electrical conductivity of either the surface or the bulk of the polymer film, without negatively influencing the reflective or transmittive properties. Simply coating the polymer/air interface with a metal will lead to a certain absorption of light that in some applications is undesired.

This invention relates to controlling the surface conductivity of the polymer film used in TDG modulators based on total internal reflection. Methods are presented that increase the electrical conductivity of the polymer film surface without negatively influencing other important parameters, such as the total internal reflection, the transmittance of the polymer, the sensitivity of the modulator and the overall dynamic response.

### BRIEF DESCRIPTION OF THE DRAWINGS

FIG. 1 shows an embodiment of the Tuneable Diffraction Grating (TDG) optical chip as known from prior art (U.S. Pat. No. 6,897,995), i) overview, ii) details in upper left corner.

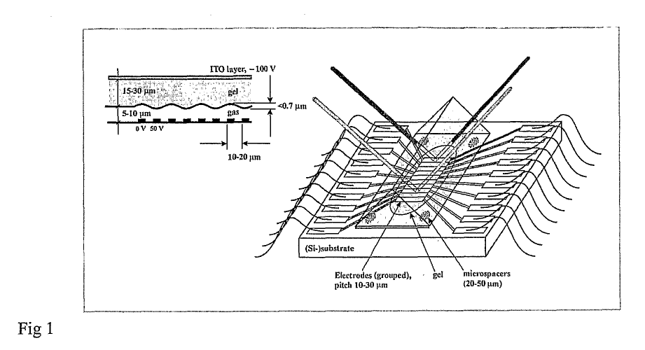

FIG. 2 shows an embodiment of a projector system where the Tuneable Diffraction Grating (TDG) optical chip is a part.

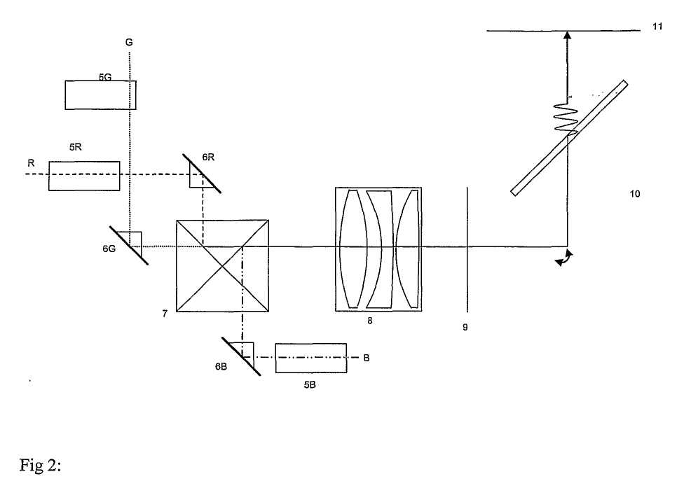

FIG. 3 shows a section of an embodiment of a light modulator as exemplified in U.S. Pat. No. 6,897,995. Electrode direction perpendicular to paper plane. Assumptions: V1 unequal to V2 and Vbias unequal to Vsubstrate.

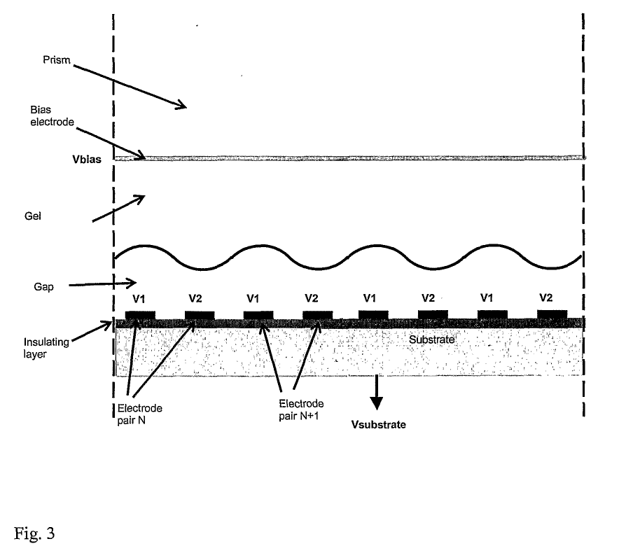

FIG. 4 shows response of a polymer film to a step voltage, with two processes with their own time constants.

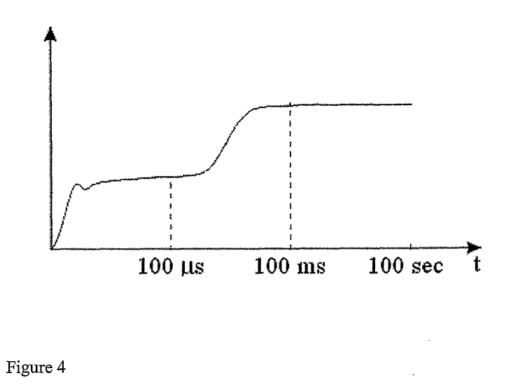

FIG. 5 is a schematic description of initial viscoelastic response and subsequent charge dislocation, followed by an additional contribution to relief amplitude.

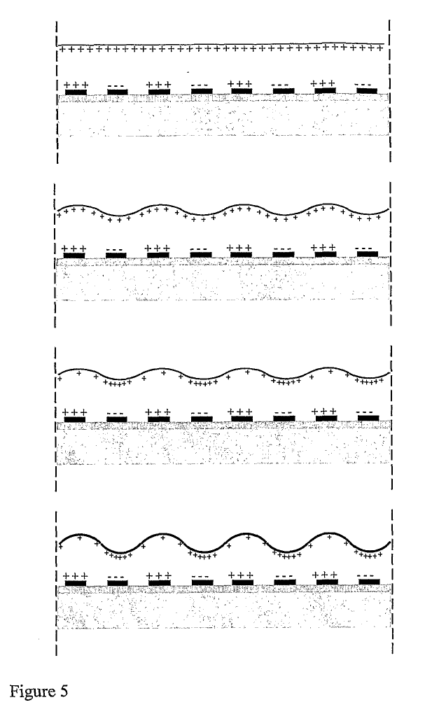

### DETAILED DESCRIPTION OF THE INVENTION

Traditionally, in TDG modulators, a macromolecular gel is employed as the deformable material that is to be modulated in the nonuniform electrical field. This gel is commonly a polydimethyl siloxane gel, a crosslinked network of polydimethylsiloxane swelled with a linear polydimethyl siloxane oil, although other gel systems have been reported (see WO 01/48531 and references herein for examples).

In order to reduce the number of time constants for the dynamic response of the TIR/TDG modulator to signal voltages into one—the viscoelastic response of the polymer film—the rate of dislocation of charges on the surface of the polymer film must be faster than the viscoelastic response. For polyorganosiloxanes in general, and polydimethyl siloxanes particularly, the electrical conductivity is extremely low. This invention relates to various methods for increasing the surface conductivity of the polymer film without negatively influencing other important parameters:
1) The surface conductivity is often directly related to the bulk conductivity, one group of embodiments therefore relates to the modification of the bulk conductivity of cross-linked polyorganosiloxanes, exemplified by the following embodiments:
   i. addition of controlled amounts of ionic substances, such as
      1. group I and II metal salts of organic acids, such as benzoic, octanoic, lauric, phthalic acid etc.
      2. inorganic salts
      3. anionic and cationic silicone compounds
   ii. addition of controlled amounts of surfactants, such as
      1. anionic and cationic organic surfactants, such as sodium dodecyl sulfate, sodium dodecyl sulfonate
      2. nonionic surfactants, such as poly(ethylene oxide) graft copolymers with for example polystyrene
      3. siloxane containing nonionic surfactants, such as poly(graft-dimethyl siloxane, ethylene oxide) etc.
      4. anionic and cationic silicone surfactants
   iii. introducing minor amounts of electron rich groups in the polymer, either as non-linked substances, or included in the siloxane polymer by for example vinyl addition reactions to hydrosilyl groups (hydrosilylation), examples of embodiments are:
      1. copolymers of dimethyl, diphenyl and methylphenyl siloxanes
      2. polyorganosiloxanes containing electron rich groups such as F, CN, Cl, poly(ethylene oxide), etc.
      3. vinyl anthracene, styrene, chlorostyrene, vinyl ferrocene, vinyl biphenyl, vinyl naphtalene etc.
   iv. introducing small amounts of additives that increase the bulk conductivity, such as water, alcohols etc.
   v. introducing electrically conductive nanoparticles such as, Au and other metals, fullerenes, metal coated silica particles etc.
2) Directly modifying the surface conductivity of the polyorganosiloxane polymer film in a separate production step, exemplified by the following embodiments:
   i. Coating the polymer surface with an electrically conducting polymer, such as polyaniline, polypyrrole, polythiophenes and others
   ii. Adsorbing mono- or multilayers of polyelectrolytes, such as polyallylamine hydrochloride, polyacrylic acid (metal salt) and others
   iii. coating the polymer surface with a metal, such as Au, Ag, Al and others
   iv. coating the polymer surface with an electrically conducting metal oxide, such as indium tin oxide, titanium oxide etc.
   v. adsorbing electron, dipole or ion conducting substances on the polymer surface, such as
      1. anionic and cationic organic surfactants, such as sodium dodecyl sulfate, sodium dodecyl sulfonate
      2. nonionic surfactants, such as poly(ethylene oxide) graft copolymers with for example polystyrene, sorbitane surfactants, alkyl poly(ethylene oxides) etc.
      3. siloxane containing nonionic surfactants, such as poly(graft-dimethyl siloxane, ethylene oxide) etc.
      4. polyorganosiloxanes modified with functional groups such as biphenyl, anthracene, naphtalene, phenyl, etc.
   vi. plasma or radiation treatment of the polymer surface
   vii. chemically modifying the polymer surface by for example
      1. reacting functional chemicals containing appropriate reactive groups with for example residual vinyl, hydride, epoxy groups on the polymer surface
      2. reacting functional substances with plasma or radiation activated surfaces.

For the examples of embodiments involving surface modification, it is important to obtain an optimal combination of thickness and conductivity of the conducting layer, in order to have a good enough conductivity and with a minimum of optical loss. The optimal conductivity is in practice determined by the viscoelastic response of the polymer film. For example, if the viscoelastic response is 1 μs, the surface resistivity should be no more than 5000 MOhm, in order for the dislocation of charges to be quicker than 1 μs after the onset of a signal voltage pulse.

It is also contemplated to combine processes from groups 1) and 2) above and thus influence both the bulk and surface conductivity of the polymer.

In all processes, the base polymer is a polyorganosiloxane gel or elastomer, including polydimethyl siloxane, copolymers of dimethyl, diphenyl and methylphenyl siloxanes, polydiethyl siloxanes, etc.

1. A method for increasing the surface conductivity of a polymer for use as the deformable material in a tuneable diffraction grating (TDG) modulator while at the same time maintaining the total internal reflection (TIR) and transparency, comprising modifying the bulk conductivity of the polymer by adding components that enhance the bulk conductivity.

2. The method according to claim 1, wherein group I and II metal salts of organic acids, inorganic or anionic or cationic silicone compounds are added to the polymer.

3. The method according to claim 1, wherein surfactants are added to the polymer.

4. The method according to claim 1, wherein minor amounts of electron rich groups are added to the polymer, as non-linked substances or included in the polymer.

5. The method according to claim 1, wherein small amounts of additives that increase the bulk conductivity, in the form of water or alcohols are added to the polymer.

6. The method according to claim 1, wherein electrically conducting nanoparticles are added.

7. A method for increasing the surface conductivity of a polymer for use as the deformable material in a tuneable diffraction grating (TDG) modulator while at the same time maintaining the total internal reflection (TIR) and transparency, comprising direct modification of the electrical conductivity of the surface layer.

8. The method according to claim 7, wherein the polymer surface is coated with a metal.

9. The method according to claim 7, wherein the polymer surface is coated with an electrically conducting metal oxide, such as indium tin oxide or titanium oxide.

10. The method according to claim 7, wherein the polymer surface is coated with an electrically conducting polymer.

11. The method according to claim 7, wherein mono- or multilayers of polyelectrolytes are adsorbed on the polymer surface.

12. The method according to claim 7, wherein electron-, dipole- or ion conducting substances are adsorbed on the polymer surface.

13. The method according to claim 12, wherein an anionic or cationic surfactant is adsorbed on the polymer surface.

14. The method according to claim 12, wherein a non-ionic surfactant is adsorbed on the polymer surface.

15. The method according to claim 12, wherein polyorganosiloxane modified with functional groups is adsorbed on the polymer surface.

16. The method according to claim 7, wherein the surface is plasma- or radiation treated.

17. The method according to claim 7, wherein the polymer surface is subjected to chemical modification.

18. The method according to claim 17, comprising reacting functional chemicals containing reactive functional groups with residual vinyl, hydride, epoxy groups on the polymer surface.

19. The method according to claim 17, comprising reacting functional substance with plasma- or radiation activated surfaces.

20. A method for increasing the surface conductivity of a polymer to be used as the deformable material in a tuneable diffraction grating (TDG) modulator while at the same time maintaining the total internal reflection (TIR) and transparency, comprising modifying the bulk conductivity of the polymer by adding components to enhance the bulk conductivity together with direct modification of the electrical conductivity of the surface layer.
